(19) United States
(12) Patent Application Publication
(10) Pub. No.: US 2011/0276829 A1
(43) Pub. Date: Nov. 10, 2011

(54) CLIENT SERVER AND METHOD FOR MONITORING FUNCTION TESTS THEREOF

(75) Inventors: CHAO-DONG PENG, Shenzhen City (CN); YANG ZHONG, Shenzhen City (CN); JI-BAO CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/941,078

(22) Filed: Nov. 7, 2010

(30) Foreign Application Priority Data
May 10, 2010 (CN) 201010168077.1

(51) Int. Cl. G06F 11/22; G06F 11/27

(52) U.S. Cl. 714/30; 714/25; 714/E11.149; 714/E11.169

(57) ABSTRACT

A client server and a test monitoring method for the client server include receiving a customization Intelligent Platform Management Interface (IPMI) from the monitor server and parsing the customization IPMI command to be a command suitable for the client server. The monitor method further includes obtaining a test result of the customization IPMI command and transmitting a determined IPMI return value corresponding to the test result to the monitor server, with the monitor server recording a test of the customization IPMI command.

### BACKGROUND

1. Technical Field

Embodiments of the present disclosure relate to monitoring technology, and in particular, to a client server and method for monitoring function tests of the client server.

2. Description of Related Art

During commonly executed procedures of when a client server is being monitored, a monitor server monitors function tests of the client server with an implemented operating system (OS). However, function tests of the client server cannot be monitored if the OS has not started up, such as a test situation in a basic input output system (BIOS) environment, unless extra hardware is added.

### BRIEF DESCRIPTION OF THE DRAWINGS

FIG. 1 is a schematic diagram of one embodiment of a monitor server and a client server.

FIG. 2 is a flowchart of one embodiment of a method for monitoring function tests of the client server, such as, for example, that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system.

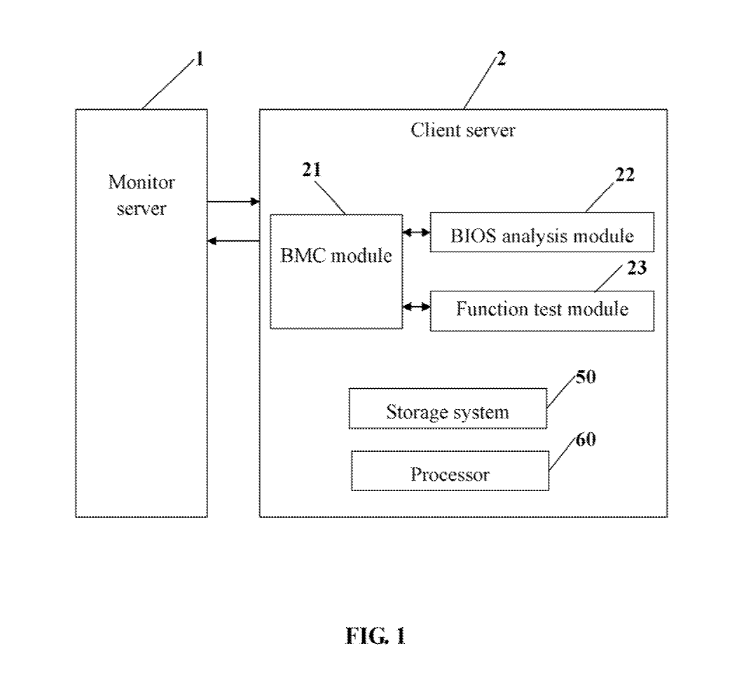

FIG. 1 is a schematic diagram of one embodiment of a client server 2 in communication with a monitor server 1. The client server 2 may execute function test commands from the monitor server 1, and return test results of the function tests to the monitor server 1. The client server 2 includes a storage system 50 and a processor 60. The storage system 50 may be a memory system of the client server 2. The processor 60 executes one or more computerized code of the client server 2 and other applications, to provide the functions of the client server 2.

In some embodiments, the client server 2 can include a baseboard management controller (BMC) module 21, a basic input/output system (BIOS) analysis module 22, and a function test module 23. The modules 21-23 may comprise computerized code in the form of one or more programs that are stored in the storage system 40. The computerized code includes instructions that are executed by the processor 60 to provide functions for modules 21-23. Details of these operations follow.

The BMC module 21 may be a communication and management module between the monitor server 1 and the client server 2. The BMC module 21 may parse customization Intelligent Platform Management Interface (IPMI) commands sent by the monitor server 1 to be corresponding commands suitable for the client server 2. The customization IPMI commands may be a startup IPMI command, a power-on self-test (POST) IPMI command, an IPMI command of function tests based on the OS, or a shutdown IPMI command, for example.

In some embodiments, if the monitor server 1 sends the startup IPMI command or the shutdown IPMI command to the client server 2, the BMC module 21 parses the startup IPMI command or the shutdown IPMI command. The client server 2 may execute the parsed startup IPMI command or the parsed shutdown IPMI command, and return a test result of the parsed startup IPMI command or a test result of the parsed shutdown IPMI command. The test result represents whether the parsed customization IPMI command is executed successfully, with each test result of the parsed customization IPMI command having corresponding IPMI return value.

If the monitor server 1 sends the POST IPMI command to the client server 2, the BMC module 21 parses the POST IPMI command, and transmits the parsed POST IPMI command to the BIOS analysis module 22. The BIOS analysis module 22 executes the parsed POST IPMI command to analyze hardware components of the client server 2, and returns a test result of the parsed POST IPMI command. In some embodiments, the analysis of the hardware equipments may include scanning a basic frequency of the central processing unit (CPU) of the client server 2, and analyzing and testing the memory or hard disk drive (HDD) of the client server 2, for example.

If the monitor server 1 sends the IPMI command of function tests based on the OS (function test IPMI command for simplification), the BMC module 21 parses the function test IPMI command and transmits the parsed function test IPMI command to the function test module 23. The function test module 23 executes the parsed function test IPMI command to test the function based on the OS of the client server 2, and return a test result of the parsed function test IPMI command.

In response to execution of the parsed customization IPMI command, the BMC module 21 may obtain the test result of the parsed customization IPMI command. The BMC module 21 further determines an IPMI return value corresponding to the test result, and transmits the determined IPMI return value to the monitor server 1. Detailed descriptions of the IPMI return value follow. The monitor server may confirm a test situation of the client server 2 according to the determined IPMI return value from the BMC module 21.

In some embodiments, the monitor server 1 may set an INI contrast file corresponding to each customization IPMI command, to store a standard IPMI return value of each customization IPMI command. Each customization IPMI command has a corresponding return value. For example, a customization IPMI command of “get device ID” is represented as “C1 18 01.” A standard IPMI return value of “C1 18 01” is “00 81 00 01 01 51 29 57 01 00 0d 09 01 06 01 01.” If the IPMI return value of the “C1 18 01” is different from its standard IPMI return value, that is, the “get device ID” test fails. If the IPMI return value of the “C1 18 01” is equal to the standard IPMI return value, the “get device ID” test is passed. The monitor server 1 may write the standard IPMI return value into a form of *.ini file of the customization IPMI command of “get device ID.”

The monitor server 1 may determine whether the determined IPMI return value received from the client server 1 is equal to the standard IPMI return value of the customization IPMI command. If the determined IPMI return value is equal to the standard IPMI return value, the monitor server 1 records that a test of the customization IPMI command is passed. If the determined IPMI return value is different from the standard IPMI return value, the monitor server 1 records that the test of the customization IPMI command is failed.

In some embodiments, a test order of the client server 2 may be “startup—POST-function tests based on the OS-shutdown.” That is, the startup test is executed first. Until the startup test is passed, the POST is executed. Until the POST is passed, the function tests based on the OS is executed. Finally, the shutdown test is executed. The entire test process is monitored and automatically controlled by the client server 1 and the monitor server 1.

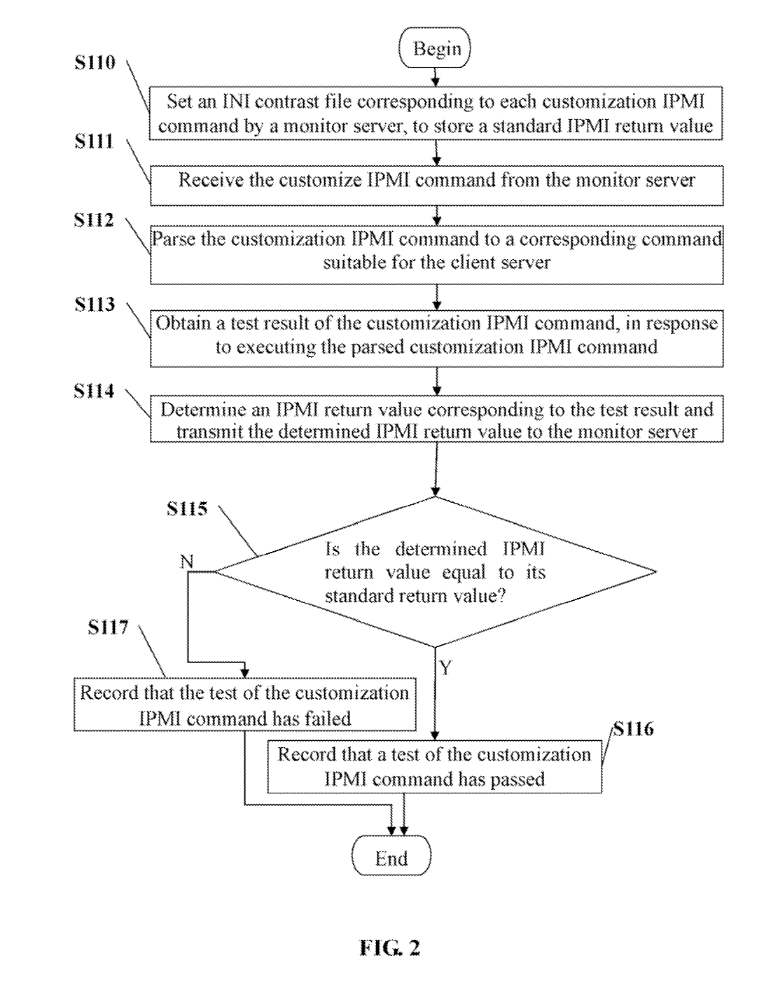

FIG. 2 is a flowchart of one embodiment of a method for monitoring function tests of a client server, such as, for example, that of FIG. 1. Depending on the embodiment, additional blocks may be added, others removed, and the ordering of the blocks may be changed.

In block S110, the monitor server 1 sets an INI contrast file corresponding to each customization IPMI command, to store standard IPMI return value of each customization IPMI command.

In block S111, the BMC module 21 receives the customization IPMI command from the monitor server 1.

In the block S112, the BMC module 21 parses the customization IPMI command to be a corresponding command suitable for the client server 2. When the monitor server 1 sends the startup IPMI command or the shutdown IPMI command, the BMC module 21 parses the startup IPMI command or the shutdown IPMI command, and the client server 2 executes the parsed startup IPMI command or the parsed shutdown IPMI command. When the monitor server 1 sends the POST IPMI command, the BMC module 21 parses the POST IPMI command and transmits to parsed POST IPMI command the BIOS analysis module 22. When the monitor server 1 sends the function test IPMI command, the BMC module 21 parses the function test IPMI command and transmits the parsed function test IPMI command to the function test module 23.

In block S113, in response to client server 2 executing the parsed IPMI command and returning the result thereof, the BMC module 21 obtains the test result. The client server 2 executes the parsed startup IPMI command or the parsed shutdown IPMI command, and returns a test result of the parsed startup IPMI command or a test result of the parsed shutdown IPMI command. The BIOS analysis module 22 executes the parsed POST IPMI command to analyze the hardware equipments of the client server 2, and returns a test result of the parsed POST IPMI command. The function test module 23 executes the parsed function test IPMI command to test the function based on the OS of the client server 2, and return a test result of the parsed function test IPMI command

In block S114, the BMC module 21 determines an IPMI return value corresponding to the test result, and transmits the determined IPMI return value to the monitor server 1.

In block S115, the monitor server 1 determines whether the determined IPMI return value is equal to a standard IPMI return value of the customization IPMI command.

If the determined IPMI return value is equal to the standard IPMI return value, in block S116, the monitor server 1 records that a test of the customization IPMI command is passed.

If the determined IPMI return value is different from the standard IPMI return value, in block S117, the monitor server 1 records that the test of the customization IPMI command is failed.

It should be emphasized that the described inventive embodiments are merely possible examples of implementations, and set forth for a clear understanding of the principles of the present disclosure. Many variations and modifications may be made to the-described inventive embodiments without departing substantially from the spirit and principles of the present disclosure. All such modifications and variations are intended to be comprised herein within the scope of this disclosure and the-described inventive embodiments, and the present disclosure is protected by the following claims.

What is claimed is:

1. A computer-implemented method for monitoring function tests of a client server, the client server in communication with a monitor server using a baseboard management controller (BMC) module, the method comprising:
(a) receiving a customization Intelligent Platform Management Interface (IPMI) command from the monitor server by the BMC module;
(b) parsing the customization IPMI command to be a corresponding command suitable for the client server by the BMC module;
(c) in response to execution of the parsed customization IPMI command in the client server, obtaining a test result of executing the parsed customization IPMI command;
(d) determining an IPMI return value corresponding to the test result, and transmitting the determined IPMI return value to the monitor server by the BMC module.

2. The method as claimed in claim 1, before step (a) further comprising:
setting an INI contrast file corresponding to each customization IPMI command, to store a standard IPMI return value for each customization IPMI command.

3. The method as claimed in claim 2, further comprising:
determining whether the determined IPMI return value is equal to a standard IPMI return value of the customization IPMI command by the monitor server;
recording that a test of the customization IPMI command has passed by the monitor server, if the determined IPMI return value is equal to the standard IPMI return value; or
recording that the test of the customization IPMI command has failed, if the determined IPMI return value is different from the standard IPMI return value.

4. The method as claimed in claim 1, wherein the customization IPMI command may be a startup IPMI command, a power-on self-test (POST) IPMI command, a IPMI command of function tests based on an operating system (OS), or a shutdown IPMI command.

5. The method as claimed in claim 4, further comprising:
in response that the BMC module receives the startup IPMI command or the shutdown IPMI command, parsing the startup IPMI command or the shutdown IPMI command by the BMC module; and
executing the parsed startup IPMI command or the parsed shutdown IPMI command, and returning a test result of the parsed startup IPMI command or the parsed shutdown IPMI command by the client server.

6. The method as claimed in claim 4, further comprising:
in response that the BMC module receives the POST IPMI command, parsing the POST IPMI command to a basic input/output system (BIOS) analysis module in the client server by the BMC module; and
executing the parsed POST IPMI command to analyze hardware equipments of the client server, and returning a test result of the parsed POST IPMI command by the BIOS analysis module.

7. The method as claimed in claim 4, further comprising:
in response that the BMC module receives the IPMI command of function tests based on the OS, parsing the IPMI command of function tests based on the OS to a function test module in the client server by the BMC module; and
executing the parsed IPMI command of function tests based on the OS to test the function based on the OS of the client server, and returning a test result of the parsed IPMI command of function tests based on the OS by the function test module.

8. A storage medium storing a set of instructions, the set of instructions capable of executed by a processor to perform a method for monitoring function tests of a client server, the client server in communication with a monitor server using a baseboard management controller (BMC) module, the method comprising:
(a) receiving a customization Intelligent Platform Management Interface (IPMI) command from the monitor server by the BMC module;
(b) parsing the customization IPMI command to be a corresponding command suitable for the client server by the BMC module;
(c) in response to execution of the parsed customization IPMI command in the client server, obtaining a test result of executing the parsed customization IPMI command;
(d) determining an IPMI return value corresponding to the test result, and transmitting the determined IPMI return value to the monitor server by the BMC module.

9. The storage medium as claimed in claim 1, before step (a) further comprising:
setting an INI contrast file corresponding to each customization IPMI command, to store a standard IPMI return value for each customization IPMI command.

10. The storage medium as claimed in claim 9, further comprising:
determining whether determined IPMI return value is equal to a standard IPMI return value of the customization IPMI command by the monitor server;
recording that a test of the customization IPMI command has passed by the monitor server, if the determined IPMI return value is equal to the standard IPMI return value; or
recording that the test of the customization IPMI command has failed, if the determined IPMI return value is different from the standard IPMI return value.

11. The storage medium as claimed in claim 8, wherein the customization IPMI command may be a startup IPMI command, a power-on self-test (POST) IPMI command, a IPMI command of function tests based on an operating system (OS), or a shutdown IPMI command.

12. The storage medium as claimed in claim 11, further comprising:
in response that the BMC module receives the startup IPMI command or the shutdown IPMI command, parsing the startup IPMI command or the shutdown IPMI command by the BMC module; and
executing the parsed startup IPMI command or the parsed shutdown IPMI command, and returning a test result of the parsed startup IPMI command or a test result of the parsed shutdown IPMI command by the client server.

13. The storage medium as claimed in claim 11, further comprising:
in response that the BMC module receives the POST IPMI command, parsing the POST IPMI command to a basic input/output system (BIOS) analysis module in the client server by the BMC module; and
executing the parsed POST IPMI command to analyze hardware equipments of the client server, and returning a test result of the parsed POST IPMI command by the BIOS analysis module.

14. The storage medium as claimed in claim 11, further comprising:
in response that the BMC module receives the IPMI command of function tests based on the OS, parsing the IPMI command of function tests based on the OS to a function test module in the client server by the BMC module; and
executing the parsed IPMI command of function tests based on the OS to test the function based on the OS of the client server, and returning a test result of the parsed IPMI command of function tests based on the OS by the function test module.

15. A client server, in communication with a monitor server, comprising:
a storage system;
at least one processor; and
one or more programs stored in the storage system, executable by the at least one processor, the one or more programs comprising:
a baseboard management controller (BMC) module operable to receive a customization Intelligent Platform Management Interface (IPMI) command from the monitor server, and parse the customization IPMI command to be a corresponding command suitable for the client server;
the BMC module further operable to obtain a test result of the parsed customization IPMI command, in response to execution of the parsed customization IPMI command in the client server;
the BMC module further operable to determine an IPMI return value corresponding to the test result, and transmit the determined IPMI return value to the monitor server.

16. The client server as claimed in claim 15, wherein the customization IPMI command may be a startup IPMI command, a power-on self-test (POST) IPMI command, a IPMI command of function tests based on an operating system (OS), or a shutdown IPMI command.

17. The client server as claimed in claim 16, wherein the one or more programs further comprising:
a basic input/output system (BIOS) analysis module operable to execute a parsed POST IPMI command to analyze hardware equipments of the client server, and return a test result of the parsed POST IPMI command, in response that the BMC module parses the POST IPMI command to the BIOS analysis module;
a the function test module operable to execute a parsed IPMI command of function tests based on the OS to test the function based on the OS, and return a test result of the IPMI command function tests based on the OS, in response that the BMC module parses the parsed IPMI command of function tests based on the OS to the function test module.

18. The client server as claimed in claim 16, wherein the client server operable to execute a parsed startup IPMI command or a parsed shutdown IPMI command, and returning a test result of the parsed startup IPMI command or a test of the parsed shutdown IPMI command, in response that the BMC module parses the startup IPMI command or the shutdown IPMI command.

19. The client server as claimed in claim 15, wherein the monitor server operable to set an INI contrast file corresponding to each customization IPMI command, to store a standard IPMI return value for each customization IPMI command.

20. The digital media controller as claimed in claim 19, wherein the monitor server further operable to determine whether the determined IPMI return value is equal to a standard IPMI return value of the received customization IPMI command;
recording that a test of the customization IPMI command has passed, if the determined IPMI return value is equal to the standard IPMI return value; or
recording that the test of the customization IPMI command has failed, if the determined IPMI return value is different from the standard IPMI return value.
